(19) United States
(12) Patent Application Publication
(10) Pub. No.: US 2017/0024703 A1
(43) Pub. Date: Jan. 26, 2017

(54) DATA INTERFACE FOR TEAM ABSENCE CALENDERING

(71) Applicant: SuccessFactors, Inc., San Francisco, CA (US)

(72) Inventor: Ralf Philipp, Altlussheim (DE)

(21) Appl. No.: 14/808,957

(22) Filed: Jul. 24, 2015

(51) Int. Cl. G06Q 10/10

(52) U.S. Cl. CPC G06Q 10/1093

(57) ABSTRACT

Methods and apparatus, including computer program products, are provided for managing calendar information. In one aspect there is provided a method. The method may include generating, by at least one processor, a request message including at least one parameter defined in accordance with an interface at an absence management system; sending, by the at least one processor, the generated request message to the interface; and receiving, by the at least one processor, team absence information generated in accordance with the at least one parameter. Related systems and articles of manufacture are also disclosed.

### FIELD

The present disclosure generally relates to absence management systems.

### BACKGROUND

An absence management system may be a system used to track employee absences for a variety of reasons including pay, tracking of paid sick leave, workforce management/planning functions, and/or the like. The absence management system may include absence information, such as vacation, sickness, public holidays for a given country, scheduled workweek for a given country, and other events associated with an employee missing a workday. The absence management system may also include organizational structure information. For example, for each employee, the organizational structure information may define the employee's peers, managers, and those so-called direct reports being supervised by the employee.

### SUMMARY

Methods and apparatus, including computer program products, are provided for managing calendar information.

In one aspect there is provided a system. The system may include at least one processor and at least one memory including program code which when executed by the at least one processor causes operations comprising generating a request message including at least one parameter defined in accordance with an interface at an absence management system; sending the generated request message to the interface; and receiving team absence information generated in accordance with the at least one parameter.

In some implementations, the above-noted aspects may further include additional features described herein including one or more of the following. The at least one parameter may include at least one employee identifier requesting the generated team absence information include at one employee identified by the at least one employee identifier. The at least one parameter may include a team indicator requesting the generated team absence information include at least one team member of the at least one employee. The at least one parameter may include a peers indicator representative of at least one peer of the at least one employee. The at least one parameter may include a manager indicator requesting the generated team absence information include manager of the at least one employee. The at least one parameter may include an effective date requesting the generated team absence information to be generated using organization structure information on the effective date. The the at least one parameter may include a time period parameter requesting the generated team absence information include absences over the time period. The at least one parameter may include a full match parameter requesting the generated team absence information include employees absent over a period matching the time period. The at least one parameter may include an include only absent employees parameter requesting the generated absence information include employees absent during the time period. The at least one parameter may include an include holiday indicator requesting the generated team absence information include information for public holidays over a time period specified to the interface by a start date and an end date. The at least one parameter may include an include work schedule day indicator requesting the generated team absence information include information regarding the scheduled work day. The team absence information may be generated, based on the at least one parameter, from absence information and organizational information at the absence management system. A page may be generated for display based on the received team absence information, a page for presentation at a display.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts an example of a system including a data interface for absence management;

FIG. 2 depicts an example of organizational structure information;

FIG. 3 depicts an example of a record obtained from the data interface;

FIG. 4 depicts an example of a team absence calendar generated based on information obtained from the data interface; and

FIG. 5 depicts an example process for obtaining absence information from the data interface.

Like labels are used to refer to same or similar items in the drawings.

### DETAILED DESCRIPTION

A team absence calendar represents the junction between absence information and the organization structural information. The team absence calendar information is a valuable source of information for decision-making. For example, the team absence calendar information may be used for workforce planning, approving vacations, and/or the like. Although the team absence calendar may be resident in an absence management system, this team absence calendar information may be needed by other, third party systems. To that end, there may be a need to provide a standard interface, such as an application program interface, at the absence management system. This interface may enable other systems to obtain, or consume, the team absence calendar information via a standardized interface.

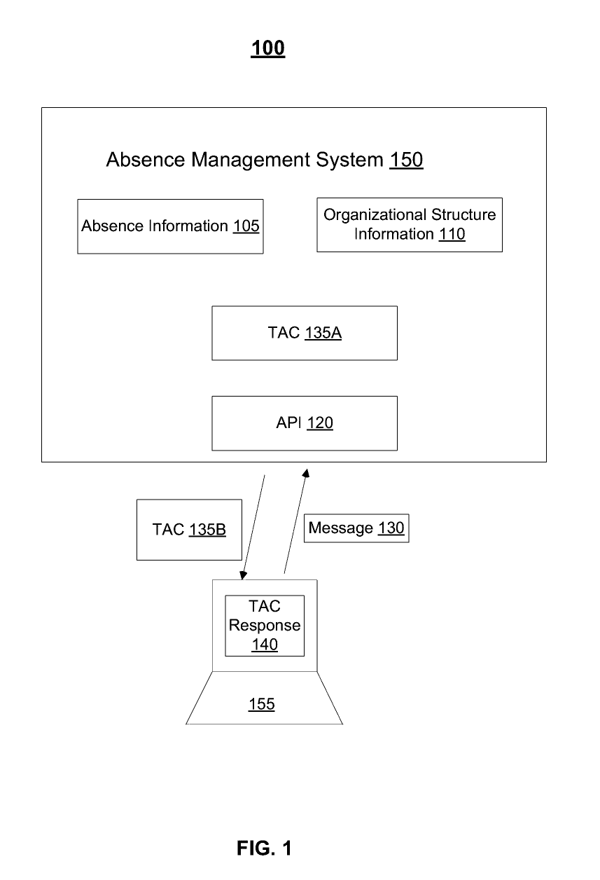

FIG. 1 depicts an example of a system 100, in accordance with some example implementations.

The system 100 may include an absence management system 155. The absence management system 155 may be implemented as at least one processor circuitry and at least one memory circuitry including program code. For example, the absence management system 155 may be implemented on one or more computers and/or other data processing devices.

The absence management system 155 may further include absence information 105, organizational structure information 110, information related to, or obtained from, the team absence calendar 135A, and an application program interface (API) 120.

For each employee, the absence information 105 may include past, current, and/or scheduled absence information. Absence information 105 may include public holidays for a given country and work schedule information for a given country (as holidays and the scheduled workweek can vary among countries). For example, holidays may be derived from the holiday calendar which might be specific to a given country, while a work schedule is assigned to the employee by the employer.

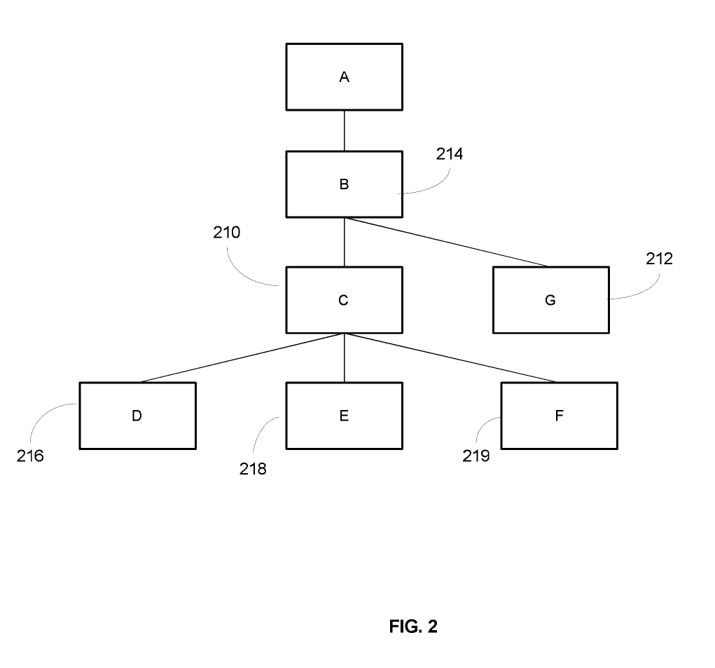

The organizational structure information 110 may define for a given employee, the given employee's peers, the given employee's manager(s), and, if the given employee supervises others, direct reports. FIG. 2 depicts an example of organizational structure information 110. In this example, each employee is represented by a letter. With respect to employee C 210, she/he is peers with employee G 212, has a manager of employee B 214, and supervises employees D 216, E 218, and F 219.

Referring again to FIG. 1, API 120 may be called by another system, such as system 155. System 155 may be implemented as at least one processor circuitry and at least one memory circuitry including program code. For example, system 155 may be implemented as a computer, a smartphone, a tablet, and/or any other data processing device coupled via wired and/or wireless networks to absence management system 150.

The API 120 may provide a standard interface for requesting the team absence calendar information 135A-B. For example, system 155 may send a request message 130 (or make a call) to API 120. The API 120 may accept the call/message in accordance with a standard format. Moreover, system 150 may store the call/message including any parameters in the call/message in memory and then gather information, based on the parameters of the call/message that is responsive to request message 130. The gathered information may then be sent in response message 135B. As such, a standard API 120 may be provided that enables enhanced communications between data processing systems 150 and 155.

The API 120 interface standard may support one or more of the following parameters: a user identifier (user ID); a team indicator; a peers indicator; a manager indicator; an effective date; a period; include only absent employees indicator; full match request indicator; include holidays indicator; and include work schedule days indicator. The values of these parameters define the content of the generated team absence calendar information 135A, which is returned at 135B. For example, request message 130 may include one or more parameters in accordance with the API 120 interface. These parameters may enable system 150 and system 155 (as well as other systems which access interface 120) to exchange information in a standard manner.

The user identifier (User ID) parameter may identify the employee for which a team absence calendar is to be generated at 135A and returned at 135B. For example, the message 130 may include a user ID of “C” to identify employee C at FIG. 2, although other types of identifiers may be used as well. If a plurality of employees are desired, the request 130 may be sent multiple times each having a single employee user ID and/or the request 130 may be sent with a plurality of employee user IDs.

The team indicator parameter may indicate whether the team absence calendar information returned at 135B should include employees reporting to the employee identified by the user ID parameter. The team indicator may be implemented as a flag or Boolean value. If the team indicator is present in a call/message to API 120, the team absence calendar information returned at 135B includes employees reporting to the employee identified by the user ID parameter. To illustrate further with reference to FIG. 2, with a user ID of “C” and a team indicator of “1” (or for example, yes, true, and/or the like), the team absence calendar information returned at 135B would include employee absence information for employees D, E, and F reporting to employee C. However, if the employee does not have any reporting team members, the API would not, of course, return any team members.

The peers indicator may indicate whether the team absence calendar information returned at 135B should include peers of the employee identified by the user ID parameter. The peers indicator may be implemented as a flag or Boolean value. If the peers indicator is present in a call/message to API 120, the team absence calendar information returned at 135B includes peers of the employee identified by the user ID parameter. To illustrate again with FIG. 2, with a user ID of “C” and a peers indicator of “1” for example, the team absence calendar information returned at 135B would include employee absence information for employee G.

The manager indicator may indicate whether the team absence calendar information returned at 135B should include manager(s) of the employee identified by the user ID parameter. The manager indicator may be implemented as a flag or Boolean value. If the manager indicator is present in a call/message to API 120, the team absence calendar information returned at 135B includes the manager of the employee identified by the user ID parameter. Referring again to FIG. 2, with a user ID of “C” and a manager indicator of “1” for example, the team absence calendar information returned at 135B would include absence information for employee B. Moreover, the indicators for manager, peer, and team may be independent in the sense that each can be evaluated separately.

The effective date parameter may define the date defining which organizational structure information to use. For example, if the effective date were Jul. 1, 2015, the team absence calendar information returned at 135B would query organizational structure information 110 for the employee's organizational structure on Jul. 1, 2015. As such, it would ignore any organization changes or other information after or before that date.

The period parameter may include a start date and an end date over which the team absence calendar evaluation should take place. For example, the generated team absence calendar 135B may be limited to include absences that start on the start date and end on the end date.

The include only absent employees indicator may be used to indicate that only absent employees should be included in the generated team absence calendar information. For example, when the include only absent employees indicator is “1” (or for example, true, yes, or the like), only absent employees are included in the generated team absence calendar information 135A that is sent at 135B. For example, an employee that is on a public holiday (or is not a scheduled workday) would not appear in the generated team absence calendar information, when the include only absent employees indicator is present in request message 130.

The full match required indicator may be used to indicate that employees that are absent on the exact days specified by the period parameter should be included in the generated team absence calendar information. The full match required indicator may be implemented as a flag or Boolean value. For example, if request 130 includes the full match required indicator as true, the team absence calendar information returned at 135 includes employees which are absent on the exact days specified by the start and end dates of the period parameter. As such, an employee that has an absence before or after the start and stop dates would not be returned at 135B in the team absence calendar information.

The include holidays indicator can control whether the API 120 returns absence information on public holidays that do fall into the period on an employee level. For example, the 4^{th} of July is public holiday in US but not in Germany, the API delivers this entry for employees in U.S. (assuming the period spans July 4th.) The include holidays indicator may be implemented as a flag or Boolean value.

The include work schedule days indicator may control whether additional information is to be provided for employees that are out due to scheduled workday should be included in the generated team absence calendar information The include work schedule days indicator may be implemented as a flag or Boolean value. For example, if request message 130 includes the include work schedule day indicator, the team absence calendar returned at 135B may include absence information for employees that are absent due to work schedule. To illustrate further, if an employee has a Sunday to Thursday work schedule with Friday and Saturday off, a request for absences on Friday, April 13 would not include that employee unless the include work schedule days indicator is true for example.

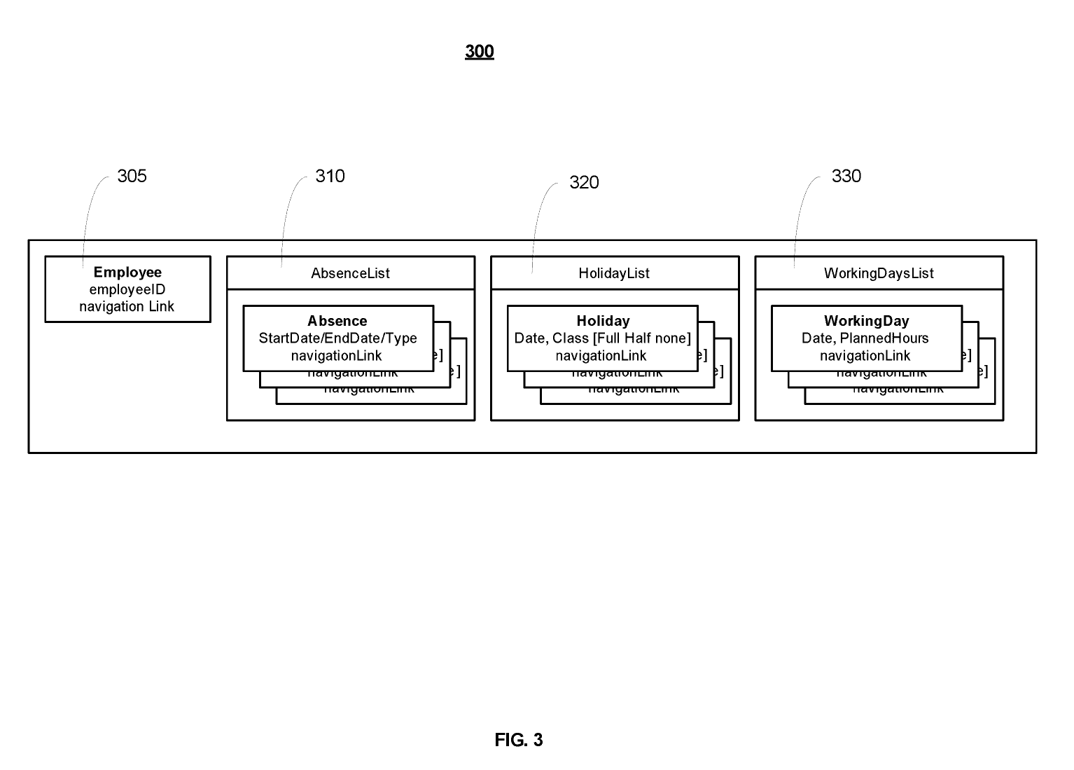

The request message 130 may thus make a call/message to API 120 to request a team absence calendar for one or more employees. The request message 130 may include one or more of the following parameters: a user identifier (user ID); a team indicator; a peers indicator; a manager indicator; an effective date; a period; include only absent employees; full match request; include holidays; and include work schedule days. Based on the values of these parameters, absence management system 150 may generate team absence calendar information 135A and sends at 135B the information to the requesting system 155, where it can be presented at 140. The team absence calendar information 135B may be formatted into one or more records, one for each employee for example. Each record may have a structure as depicted at FIG. 3. Moreover, the team absence calendar information 135B returned may also include for each employee scheduled workday information and holiday information as well.

FIG. 3 depicts an example of a data structure for a given employee 305. This data structure may be returned to the system 155 in the response provided at 135B. When a plurality of employees are returned at 135B, a data structure (or record) may be returned for each employee.

In the example of FIG. 3, the employee is identified by employee identifier (employee ID). Moreover, there may be a link to an employee entity (which can be used for obtain additional information for the employee).

In the example of FIG. 3, the response returned at 135B is structured to include a list of one or more absences 310 for employee 305, a list of one or more holidays 320 (for example, when the holiday indicator is true) for employee 305, and/or a list of one or more scheduled workdays 330 for employee 305 (for example, if the work schedule indicator is true). The lists may be nested, although non-nested lists may be used as well.

For the absence list 310, the information may include the start and end dates of each absence and a type to indicate semantics, such as paid leave, unpaid leave, military leave, and the like. The navigation link links the absence list to additional details for the absence, such as approval status, comments, and/or the like. For the holiday list 420, the information may include a description of the holiday, date of the holiday, and category (full/half/none) to indicate whether a holiday is a half day holiday or a full day holiday, or whether a holiday is not observed (for example, “none”) at a given location. The navigation link links the holiday list to details of the public holiday, such as a. description, information about whether pay is at a premium rate (for example, double time). The working day list 330 may include one or more scheduled workdays (including the planned working time in hours/days) and a navigation list to a schedule for a workday, such as a list of breaks on a working day, flex times, core times, and the like.

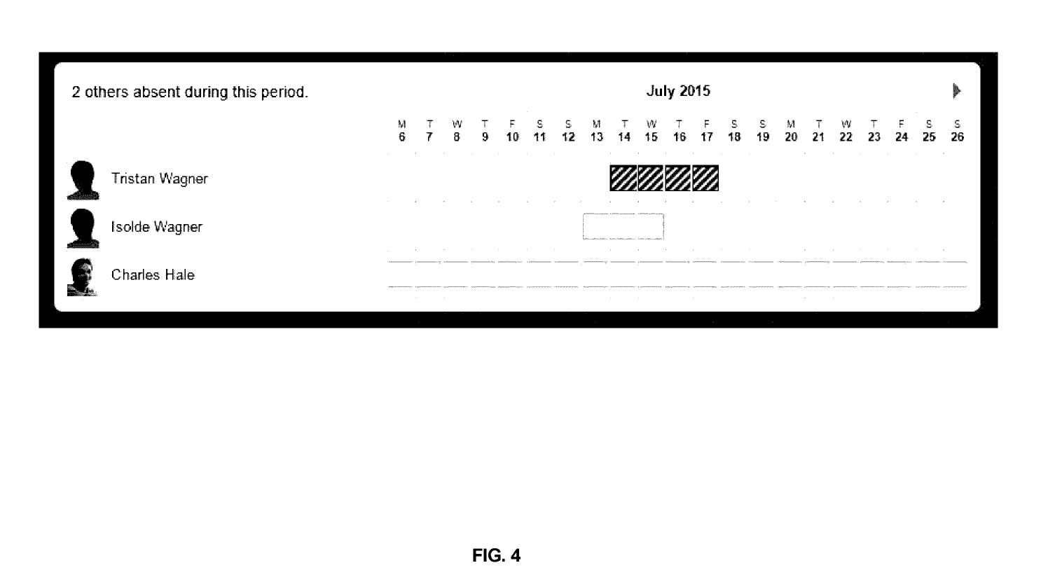

The data structure(s) of FIG. 3 may be returned at 135B and used to, as noted, create a user interface for team absences as shown in FIG. 4. For example, for each employee on a team, the absence information may be shown along with public holidays and/or scheduled workdays. The team absence calendar may be used by employees to request or schedule an absence or by a manager to approve the absence. In addition to generating a team absence calendar and/or data structures/records returned at 135B may be used perform capacity/resource planning. Moreover, automated approval of absences may be configured based on a constraints, such as if no one on the team is absent, approve absence request or if other member(s) on the team absent, reject request. In the example of FIG. 4, a manager approval screen (which can be presented at 140) is shown with a request to approve an absence request for Tristan on July 14-July 17. In this example, all absent peers reporting to the manager are shown. Specifically, the API call includes the peers indicator set to true and an “only absent” parameter for the period July 14-July 17. 07/17).

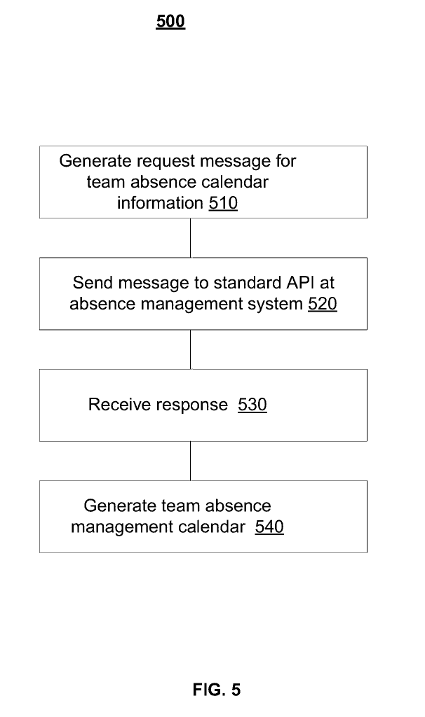

FIG. 5 depicts an example process 500 for obtaining team absence calendar information, in accordance with some example implementations. The description of FIG. 5 also refers to FIG. 1.

At 510, a message may be generated to request team absence calendar information. The message may include one or more parameters in accordance with the standard interface provided by API 120. For example, the message may include one or more of the following parameters: a user identifier (user ID); a team indicator; a peers indicator; a manager indicator; an effective date; a period; include only absent employees; full match request; include holidays; and include work schedule days. The values of these parameters define the content of the team absence calendar information.

At 520, the generated message may be sent to the absence management system. For example, system 155 may call API 120 using the generated message 130. The absence management system 150 may then read the message 130 including the one or more parameters, store the message in memory (or for example, cache), and then gather information (based on any parameters indicated in message 130) to determine what content to include in the team absence calendar information returned at 135B to system 155.

At 530, the generated team absence calendar information may be received by system 155. The received team absence calendar information may be in a format as depicted at FIG. 3, although the received information may take other forms as well.

At 540, the system 155 may generate at team absence calendar view for presentation at system 155. The information presented at the team absence calendar view (as shown at FIG. 4 for example) includes the employee(s) absence information returned in accordance with the one or more of the parameters contained in message 510. For example, whether the team includes peers, managers, and/or the like depends on the selection of parameters at 510.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A system comprising:
at least one processor; and
at least one memory including program code which when executed by the at least one processor causes operations comprising:
generating a request message including at least one parameter defined in accordance with an interface at an absence management system;
sending the generated request message to the interface; and
receiving team absence information generated in accordance with the at least one parameter.

2. The system of claim 1, wherein the at least one parameter comprises at least one employee identifier requesting the generated team absence information include at one employee identified by the at least one employee identifier.

3. The system of claim 2, wherein the at least one parameter comprises a team indicator requesting the generated team absence information include at least one team member of the at least one employee.

4. The system of claim 2, wherein the at least one parameter comprises a peers indicator representative of at least one peer of the at least one employee.

5. The system of claim 1, wherein the at least one parameter comprises a manager indicator requesting the generated team absence information include at least one manager of the at least one employee.

6. The system of claim 1, wherein the at least one parameter comprises an effective date requesting the generated team absence information to be generated using organization structure information on the effective date.

7. The system of claim 1, wherein the at least one parameter comprises a time period parameter requesting the generated team absence information include absences over the time period.

8. The system of claim 7, wherein the at least one parameter comprises a full match parameter requesting the generated team absence information include employees absent over a period matching the time period.

9. The system of claim 7, wherein the at least one parameter comprises an include only absent employees parameter requesting the generated absence information include employees absent during the time period.

10. The system of claim 1, wherein the at least one parameter comprises an include holiday indicator requesting the generated team absence information include information for public holidays over a time period specified to the interface by a start date and an end date.

11. The system of claim 1, wherein the at least one parameter comprises an include work schedule day indicator requesting the generated team absence information include information regarding the scheduled work day.

12. The system of claim 1 further comprising:
generating, based on the at least one parameter, the team absence information from absence information and organizational information at the absence management system.

13. The system of claim 1 further comprising:
generating, based on the received team absence information, a page for presentation at a display.

14. A non-transitory computer-readable storage medium including program code which when executed by at least one processor causes operations comprising:
generating a request message including at least one parameter defined in accordance with an interface at an absence management system;
sending the generated request message to the interface; and
receiving team absence information generated in accordance with the at least one parameter.

15. The non-transitory computer-readable storage medium of claim 14, wherein the at least one parameter comprises at least one employee identifier requesting the generated team absence information include at one employee identified by the at least one employee identifier.

16. The non-transitory computer-readable storage medium of claim 15, wherein the at least one parameter comprises a team indicator requesting the generated team absence information include at least one team member of the at least one employee.

17. A method comprising:
generating, by at least one processor, a request message including at least one parameter defined in accordance with an interface at an absence management system;
sending, by the at least one processor, the generated request message to the interface; and
receiving, by the at least one processor, team absence information generated in accordance with the at least one parameter.

18. The method of claim 17, wherein the at least one parameter comprises at least one employee identifier requesting the generated team absence information include at one employee identified by the at least one employee identifier.

19. The method of claim 18, wherein the at least one parameter comprises a team indicator requesting the generated team absence information include at least one team member of the at least one employee.

20. The method of claim 18, wherein the at least one parameter comprises a peers indicator representative of at least one peer of the at least one employee.
